(19) United States
(12) Patent Application Publication
(10) Pub. No.: US 2008/0268675 A1
(43) Pub. Date: Oct. 30, 2008

(54) Contact and Electrical Connector

(76) Inventors: Mitsuru Suzuki, Kanagawa (JP); Naoki Hayashi, Tokyo (JP)

Correspondence Address: BARLEY SNYDER, LLC, 1000 WESTLAKES DRIVE, SUITE 275, BERWYN, PA, 19312, US

(21) Appl. No.: 12/103,957

(22) Filed: Apr. 16, 2008

(30) Foreign Application Priority Data
Apr. 25, 2007 (JP) 2007-116162

(51) Int. Cl. H01R 13/15

(52) U.S. Cl. 439/82

(57) ABSTRACT

A contact that makes electrical contact with a flat plate-form mating contact includes a base having a fastening member for securing the base to an insulating housing of an electrical connector, a first spring that extends upward from the base, a linking member that extends downward from a tip end of the first spring, and a second spring that is more easily flexed than the first spring that extends upward from a lower end of the linking member. The second spring has a contact member at a tip end thereof. The first spring moves the contact member in a first direction when a contact force is applied to the contact member in a direction of the base, and the second spring moves the contact member in a second direction opposite from the first direction when a further contact force is applied to the contact member in a direction of the base.

### CROSS-REFERENCE TO RELATED APPLICATIONS

This application claims the benefit of the filing date under 35 U.S.C. § 119(a)-(d) of Japanese Patent Application No. 2007-116162, filed Apr. 25, 2007.

### FIELD OF THE INVENTION

The present invention relates to contacts used when a circuit board and a semiconductor package such as a land grid array (LGA) package and fine-pitch land grid array (FLGA) package are connected, and an electrical connector comprising such contacts.

### BACKGROUND

In recent years, semiconductor packages such as LGA packages and FLGA packages have been developed to meet the miniaturization of semiconductor packages for recording media or the like. Such a semiconductor package comprises an insulating housing and a plurality of mating contacts that are arranged on the undersurface of the housing in the form of a grid. There are cases in which foreign matter such as resin fragments and dust adheres to surfaces of the mating contacts of the semiconductor package. Furthermore, when the semiconductor package in which foreign matter adheres to the surfaces of the mating contacts is attached to an electrical connector, the contact between the mating contacts of the semiconductor package and contacts of the electrical connector becomes insufficient causing loose connections. Accordingly, an electrical connector has been developed which removes foreign matter adhering to surfaces of mating contacts of a semiconductor package by wiping the mating contacts with contacts of the connector when the semiconductor package is attached to the electrical connector.

FIG. 15 shows an example of a conventional electrical connector 100 (see JP11-297,406A), which has been known in the past as an electrical connector of this type. As shown in FIG. 15, the electrical connector 100 comprises a housing 110 and contacts 120 secured to the housing 110. Each of the contacts 120 comprises a press-fitting projection 123 that is secured to the housing 110 and a holding member 122 that is connected to a lower end portion of the press-fitting projection 123 and that extends in a forward-rearward direction (left-right direction in FIG. 15). Each of the contacts 120 further comprises a lead member 121 that extends rearward (leftward in FIG. 15) from a rear end portion of the holding member 122, an arm 124 that extends upward from a front end portion of the holding member 122 and then extends forward (rightward in FIG. 15), and a tip-end protruding member 125 that extends upward from a front end portion of the arm 124.

The contacts 120 are inserted into contact holding grooves 111 in the housing 110 and are secured to the housing 110 as a result of the press-fitting projections 123 of the contacts 120 being press-fitted into contact openings 112 in the housing 110. The lead members 121 of the contacts 120 are attached to a board. The tip-end protruding members 125 of the contacts 120 secured to the housing 110 protrude upward from upper ends of tip-end protruding member guide holes 113 in the housing 110.

When a semiconductor package 130 is secured to the electrical connector 100, mating contacts 131 of the semiconductor package 130 push down the upper ends of the tip-end protruding members 125 of the contacts 120 of the electrical connector 100. In this case, as is indicated by the dotted line in FIG. 15, the upper ends of the tip-end protruding members 125 move forward as a result of the arms 124 of the contacts 120 being displaced downward. Consequently, the upper ends of the tip-end protruding members 125 of the contacts 120 of the electrical connector 100 wipe the surfaces of the mating contacts 131 of the semiconductor package 130, making it possible to remove the foreign matter adhering to the surfaces of the mating contacts 131.

Here, the length of the mating contacts 131 of the semiconductor package 130 that allows the contacts 120 of the electrical connector 100 to actually perform the wiping, is defined as an effective pattern length. Furthermore, in cases where contacts whose length is approximately 1.0 mm are used as the mating contacts 131 of the semiconductor package 130, the effective pattern length of the contacts 120 is approximately 0.6 mm due to the tolerance of the housing dimensions.

In cases where foreign matter adhering to the surfaces of the mating contacts 131 of the semiconductor package 130 is removed by the wiping with the contacts 120 of the electrical connector 100, a contact pressure of approximately 30 to 50 g (hereafter referred to as “required contact pressure”) is required as the contact pressure between the contacts 120 of the semiconductor package 130 and the contacts 120 of the electrical connector.

Here, in the case of contacts having a cantilever spring structure such as the contacts 120 of the electrical connector 100 shown in FIG. 15, the required contact pressure is ensured only after a state is created in which the mating contacts 131 of the semiconductor package 130 push down the upper ends of the tip-end protruding members 125 of the contacts 120, causing the upper ends of the tip-end protruding members 125 to move forward approximately 0.3 mm.

Therefore, the distance to which the contacts 120 of the electrical connector 100 can wipe the surfaces of the mating contacts 131 of the semiconductor package 130 with the required contact pressure is approximately 0.3 mm, which is obtained by subtracting the distance to which the upper ends of the tip-end protruding members 125 move by the time that the required contact pressure is ensured (approximately 0.3 mm) from the effective pattern length (approximately 0.6 mm).

Accordingly, the distance to which the contacts 120 of the electrical connector 100 can wipe the surfaces of the mating contacts 131 of the semiconductor package 130 with the required contact pressure (hereafter referred to as “effective wiping distance”) is short, so that there is a problem in that there are cases in which foreign matter adhering to the surfaces of the mating contacts 131 cannot be removed completely.

### SUMMARY

It is an object of the present invention to provide a contact which makes it possible to ensure a long effective wiping distance, and an electrical connector comprising the aforementioned contact.

This and other objects are achieved by a contact that makes electrical contact with a flat plate-form mating contact comprising a base having a fastening member for securing the base to an insulating housing of an electrical connector, a first spring that extends upward from the base, a linking member that extends downward from a tip end of the first spring, and a second spring that is more easily flexed than the first spring that extends upward from a lower end of the linking member. The second spring has a contact member at a tip end thereof. The first spring moves the contact member in a first direction when a contact force is applied to the contact member in a direction of the base, and the second spring moves the contact member in a second direction opposite from the first direction when a further contact force is applied to the contact member in a direction of the base.

This and other objects are further achieved by an electrical connector that receives a semiconductor package comprising an insulating housing provided with a plurality of contacts. Each of the contacts has a base with a fastening member for securing the base to the insulating housing. A first spring extends upward from the base. A linking member extends downward from a tip end of the first spring. A second spring that is more easily flexed than the first spring extends upward from a lower end of the linking member. The second spring has a contact member at a tip end thereof. The first spring moves the contact member in a first direction when a contact force is applied to the contact member in a direction of the base, and the second spring moves the contact member in a second direction opposite from the first direction when a further contact force is applied to the contact member in a direction of the base.

### BRIEF DESCRIPTION OF THE DRAWINGS

FIG. 1 is a perspective view of an upper surface of an electrical connector according to an embodiment of the present invention;

FIG. 2 is a sectional view along a direction of length of the electrical connector shown in FIG. 1 showing a side of the upper surface;

FIG. 3 is a sectional view is a sectional view along a direction of width of the electrical connector shown in FIG. 1 showing a side of an undersurface;

FIG. 4 is a perspective view of the electrical connector shown in FIG. 1 with a protective cover removed;

FIG. 5 is a sectional view along a direction of length of the electrical connector shown in FIG. 4 showing a side of the upper surface;

FIG. 6 is a sectional view along a direction of width of the electrical connector shown in FIG. 4 showing a side of the upper surface;

FIG. 7 is a perspective view of a contact provided in the electrical connector shown in FIG. 1;

FIG. 8 is a perspective view of the electrical connector shown in FIG. 1 showing the protective cover located in a lower position;

FIG. 9 is a sectional view along a direction of length of the electrical connector shown in FIG. 8 showing the side of the upper surface;

FIG. 10 is a side view of the contact shown in FIG. 7 showing a state in which a contact member is located in a first position;

FIG. 11 is a side view of the contact shown in FIG. 7 showing a state in which the contact member is pushed to a second position;

FIG. 12 is a side view of the contact shown in FIG. 7 showing a state in which the contact member is pushed to a third position;

FIG. 13 is a perspective view of the electrical connector shown in FIG. 1 showing the side of the upper surface in a state in which an FLGA package is secured;

FIG. 14 is a sectional view along a direction of length of the electrical connector shown in FIG. 13 showing the side of the upper surface; and

FIG. 15 is a sectional side view of a conventional electrical connector.

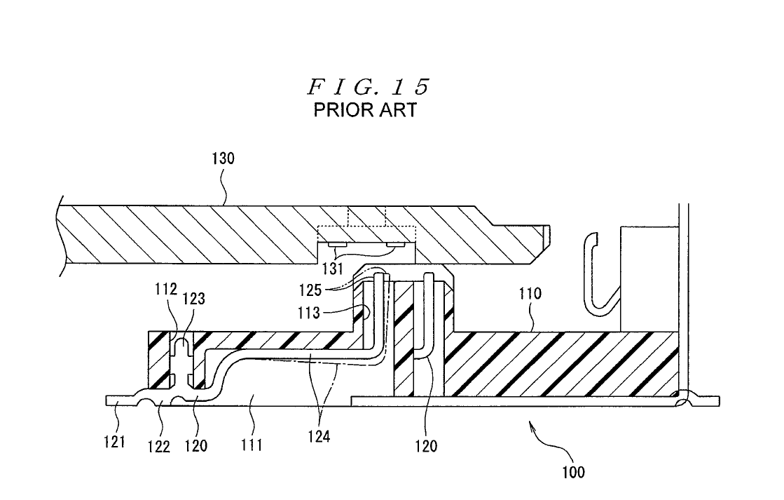

### DETAILED DESCRIPTION OF THE EMBODIMENT(S)

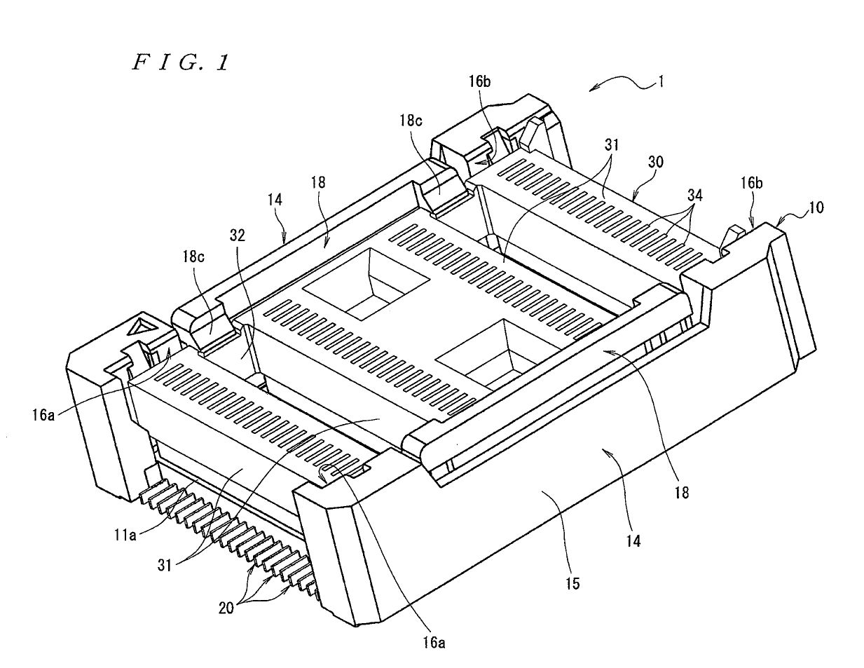

FIGS. 1-5 show an electrical connector 1 according to an embodiment of the present invention. The electrical connector 1 can be constructed to connect a circuit board and a semiconductor package such as an LGA package (not shown) or a FLGA package T. In the embodiment shown and described herein, the electrical connector is constructed for the FLGA package T.

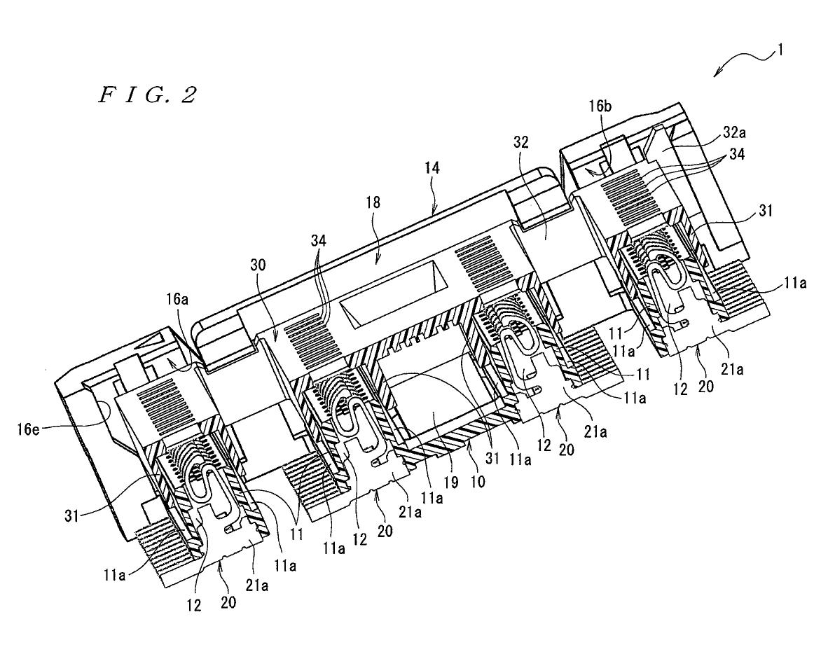

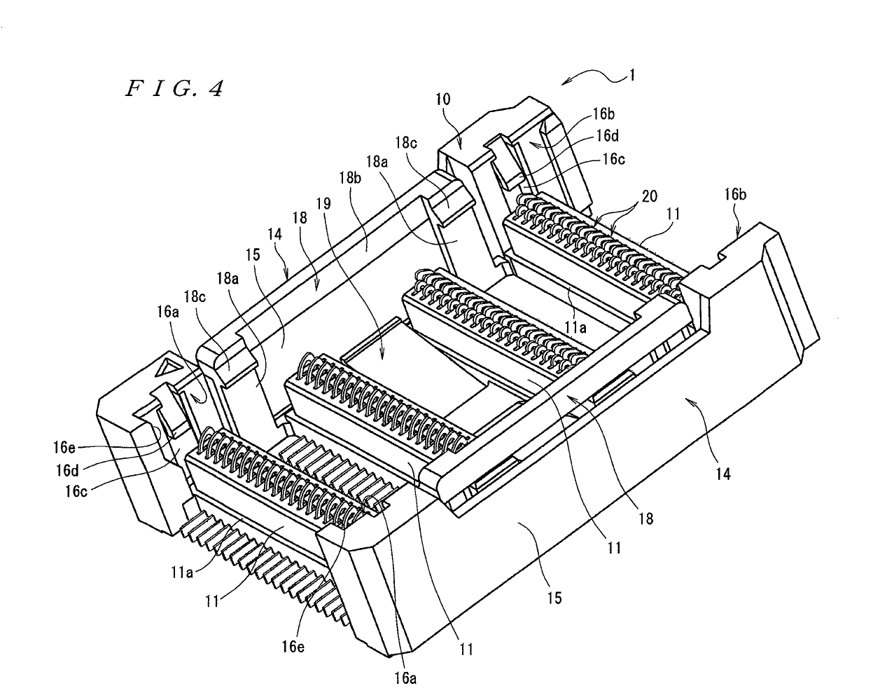

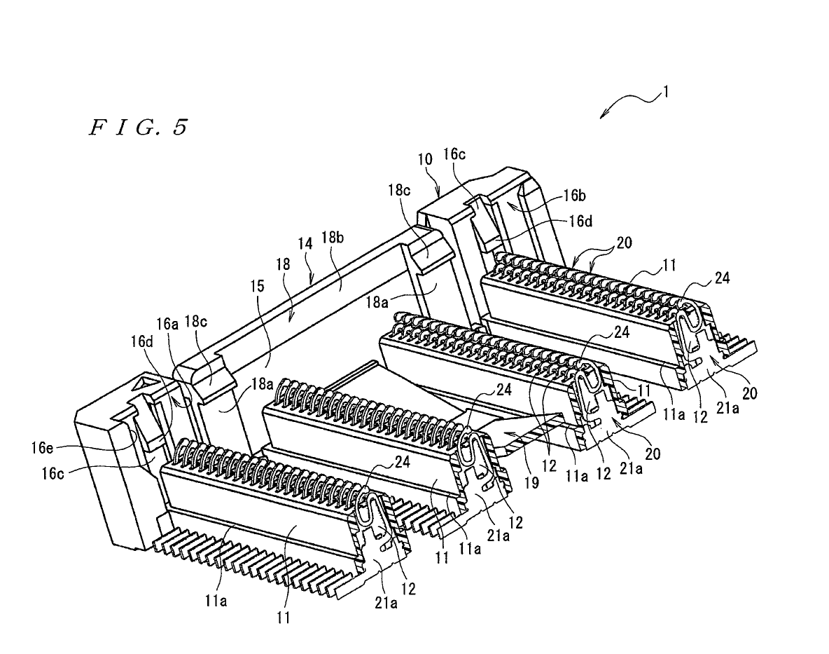

As shown in FIG. 1, the electrical connector 1 comprises a housing 10. The housing 10 may be formed, for example, by molding an insulating resin. As shown in FIGS. 2 and 4, the housing 10 comprises contact accommodating sections 11 that extend in a direction of width (in a direction from a right side closer to a viewer toward a left side away from the viewer in FIG. 4). The contact accommodating sections 11 are arranged substantially parallel to each other along a direction of length (the direction from a left side closer to the viewer toward a right side away from the viewer in FIG. 4). As shown in FIG. 5, a plurality of contact accommodating grooves 12 are formed in each of the contact accommodating sections 11 at a specified pitch along the direction of width. Step parts 11a that extend in the direction of width are provided on lower end portions of outer surfaces of each of the contact accommodating sections 11.

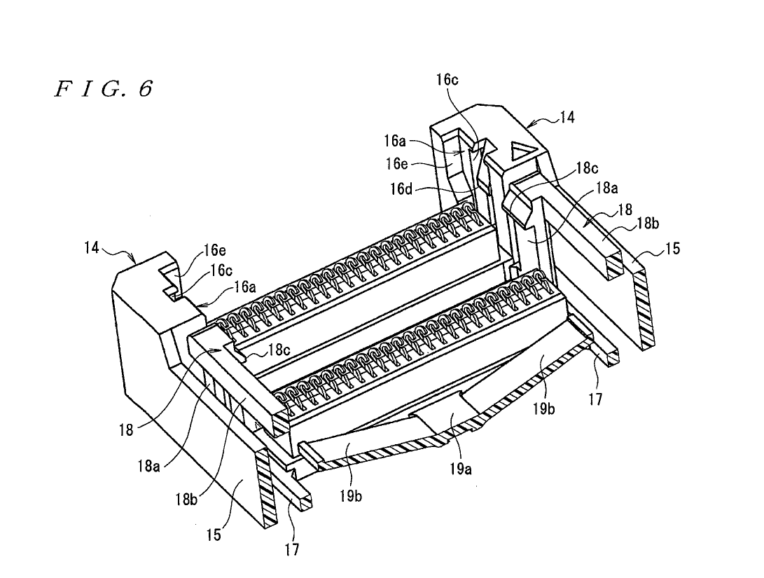

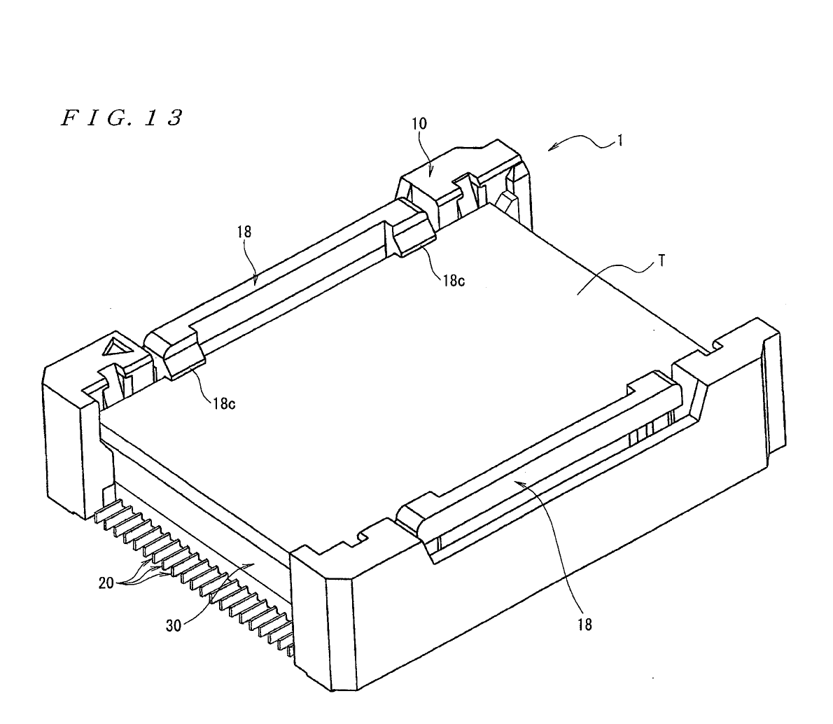

A pair of side walls 14 link end portions of the contact accommodating sections 11 to each other. As shown in FIGS. 5 and 6, each of the side walls 14 comprises an outer wall 15 that extends in the direction of length. Guide members 16a, 16b are provided at end portions of the outer wall 15 in the direction of length. As shown in FIGS. 5 and 6, the guide members 16a, 16b extend in the vertical direction (vertical direction in FIGS. 5 and 6). A guide groove 16c is formed in each of the guide members 16a, 16b so as to extend in the vertical direction. The guide grooves 16c are provided with stoppers 16d. The guide members 16a on the front side are provided with positioning protruding members 16e with which two corners of the FLGA package T (FIG. 13) make contact when the FLGA package T is secured to the electrical connector 1.

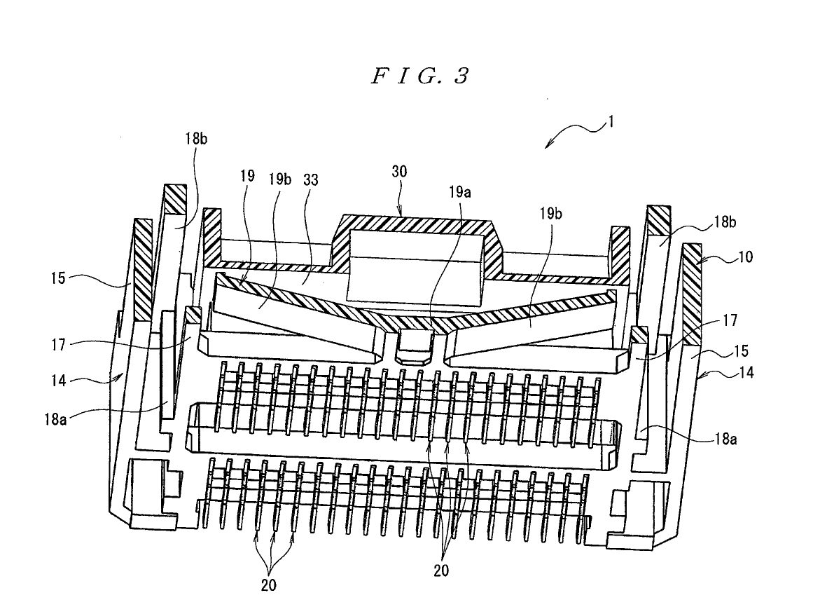

As shown in FIGS. 3 and 6, a connecting member 17 links lower end portions of the guide members 16a, 16b to each other. The connecting members 17 link the individual end portions in the direction of width (in the left-right direction in FIG. 3 and in the direction from the left side closer to the viewer toward the right side away from the viewer in FIG. 6) of the contact accommodating sections 11 to each other. As a result, the contact accommodating sections 11 are connected to two sets of the guide members 16a, 16b via the connecting members 17.

As shown in FIG. 6, a locking member 18 is secured to the connecting member 17. Each of the locking members 18 comprises a pair of elastic plates 18a that extend upward from the connecting member 17. A linking plate 18b links upper ends of the elastic plates 18a to each other, as shown in FIGS. 3 and 6. The upper end of each of the elastic plates 18a is provided with a package locking piece 18c that locks an upper surface of the FLGA package T when the FLGA package T is secured to the electrical connector 1.

As shown in FIGS. 3 and 6, a plate spring 19 for supporting a protective cover 30 in a floating manner may be integrally molded with the housing 10 between the contact accommodating sections 11 disposed innermost among the contact accommodating sections 11. The plate spring 19 comprises a flat plate 19a and a pair of spring members 19b that extend diagonally upward from the flat plate 19a toward an outside in the direction of width. The flat plate 19a is disposed in a position lower than the lower end portions of the contact accommodating sections 11.

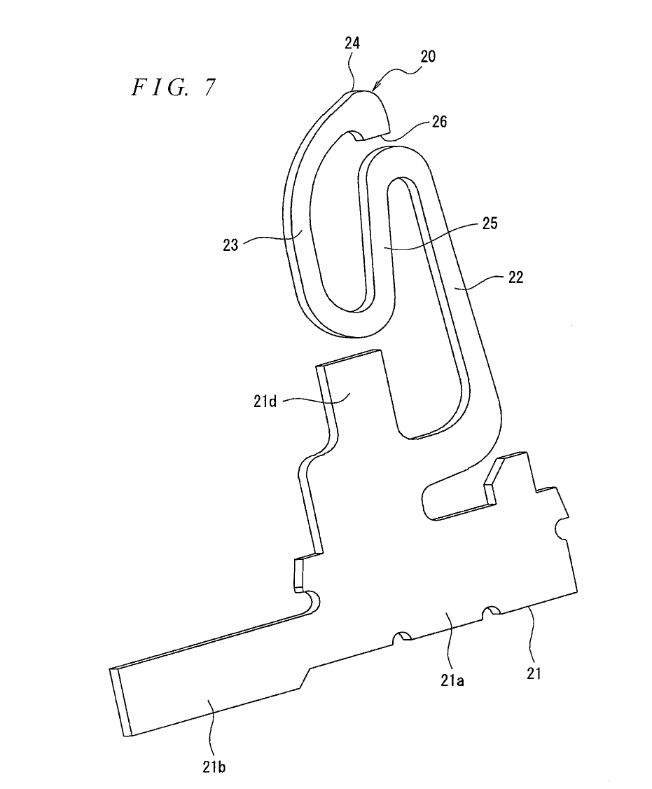

As shown in FIG. 2, a plurality of contacts 20 are secured in each of the contact accommodating sections 11 at a specified pitch along the direction of width. As shown in FIG. 7, each of the contacts 20 comprises a base 21 that is secured to the housing 10, a first spring 22 that extends upward from the base 21, a second spring 23 that extends upward from the first spring 22, and a contact member 24 that is provided at a tip end of the second spring 23 on a side of an upper surface thereof.

The base 21 comprises a fastening member 21a that extends in the direction of length (in the direction from the left side closer to the viewer toward the right side away from the viewer in FIG. 7). A board connecting member 21b is provided to a front side (to the left side closer to the viewer in FIG. 7) of the fastening member 21a and is connected to a circuit board (not shown). An anti-overstress member 21d protrudes upward from the fastening member 21a.

The first spring 22 is formed substantially in the shape of a backward letter C, as shown in FIG. 7. The first spring 22 extends rearward (rightward and away from the viewer in FIG. 7) from one side portion of the fastening member 21a of the base 21 and then extends upward. A tip end of the first spring 22 is bent back downward.

The second spring 23 is formed substantially in the shape of the letter C, as shown in FIG. 7. The second spring 23 extends upward after being bent back from a lower end of the linking member 25 that extends downward from the tip end of the first spring 22. As a result, the first spring 22 and the second spring 23 are formed substantially into the shape of the letter S via the linking member 25. In this case, the first spring 22 and the second spring 23 are formed such that when the contact member 24 is pushed downward by a flat plate-form mating contact C provided on the undersurface of the FLGA package T, a direction in which the contact member 24 is caused to move by the flexing of the first spring 22 and a direction in which the contact member 24 is caused to move by the flexing of the second spring 23 are opposite from each other. Moreover, the second spring 23 is formed so as to flex more easily than the first spring 22.

The contact member 24 that contacts the mating contact C provided on the undersurface of the FLGA package T when the FLGA package T is secured to the electrical connector 1 is provided at a tip end of the second spring 23 on a side of an upper surface thereof. A abutment member 26 that contacts an upper end of the first spring 22 when the second spring 23 flexes as a result of the contact member 24 being pushed downward by the mating contact C provided on the undersurface of the FLGA package T is formed at a tip end of the second spring 23 on a side of an undersurface thereof.

The protective cover 30 may be formed, for example, by molding an insulating resin. As shown in FIGS. 1 and 2, the protective cover 30 comprises a plurality of cover members 31 that extend in the direction of width and a pair of side walls 32 that link end portions of the cover members 31 to each other in the direction of width. As shown in FIG. 2, each of the cover members 31 is formed in the shape of a box whose undersurface is open. The cover members 31 are arranged substantially parallel to each other along the direction of length. The cover members 31 are constructed such that the cover members 31 can cover an outside of the contact accommodating sections 11 when the protective cover 30 is mounted to the housing 10. A plurality of slots 34 that allow the contact members 24 of the contacts 20 to protrude upward are formed in an upper surface of each of the cover members 31. The slots 34 are formed in positions corresponding to the contact accommodating grooves 12 formed in each of the contact accommodating sections 11 when the cover members 31 are caused to cover the contact accommodating sections 11. As shown in FIG. 3, a push-up plate 33 with which tip ends of the spring members 19b of the plate spring 19 make contact when the protective cover 30 is mounted to the housing 10 is installed across lower end portions of the cover members 31 that are innermost arranged.

Protruding members (not shown) that are inserted into the guide grooves 16c formed in the guide members 16a, 16b of the side walls 14 of the housing 10 are provided in the end portions in the direction of length of the outer surfaces of the side walls 32. As shown in FIG. 2, positioning protruding members 32a with which two corners of the FLGA package T make contact when the FLGA package T is secured to the electrical connector 1 are provided at rear end portions of the upper surfaces of the side walls 32.

A method for assembling the electrical connector 1 will now be described. In the assembly of the electrical connector 1, the contacts 20 are first secured to the housing 10 by being press-fitted into each of the contact accommodating grooves 12 formed in each of the contact accommodating sections 11. The contacts 20 accommodated inside the contact accommodating grooves 12 can be displaced freely inside the contact accommodating grooves 12. Because the contacts 20 are accommodated inside the contact accommodating grooves 12, the direction of displacement of the contacts 20 is restricted to a two-dimensional direction along the inner surfaces of the contact accommodating grooves 12 in the direction of width. The contact members 24 of the contacts 20 accommodated inside the contact accommodating grooves 12 protrude upward from the upper ends of the contact accommodating grooves 12.

The protective cover 30 is mounted to the housing 10 to which the contacts 20 have been mounted. In the assembly of the protective cover 30 to the housing 10, the protruding members (not shown) provided on the side walls 32 of the protective cover 30 are first inserted into the guide grooves 16c formed in the guide members 16a, 16b of the housing 10 from the upper ends of the guide grooves 16c. When the protective cover 30 is pushed down, the cover members 31 of the protective cover 30 begin to cover the contact accommodating sections 11 of the housing 10 from above. When the protective cover 30 is pushed down further, the undersurface of the push-up plate 33 of the protective cover 30 contacts the tip ends of the spring members 19b of the plate spring 19 of the housing 10, so that the spring members 19b begin to flex downward. When the protective cover 30 is pushed down to a position at which the protruding members provided on the side walls 32 of the protective cover 30 ride over the stoppers 16d provided on the guide grooves 16c in the housing 10 (hereafter referred to as an “upper position”), the lower ends of the stoppers 16d contact the protruding members (not shown), thus preventing the protruding members (not shown) from coming out of the guide grooves 16c. That is, the protective cover 30 is placed in a state in which the protective cover 30 is supported by the housing 10 in a floating manner, as a result of the push-up plate 33 being pushed up by the spring members 19b of the plate spring 19. This completes the assembly of the protective cover 30.

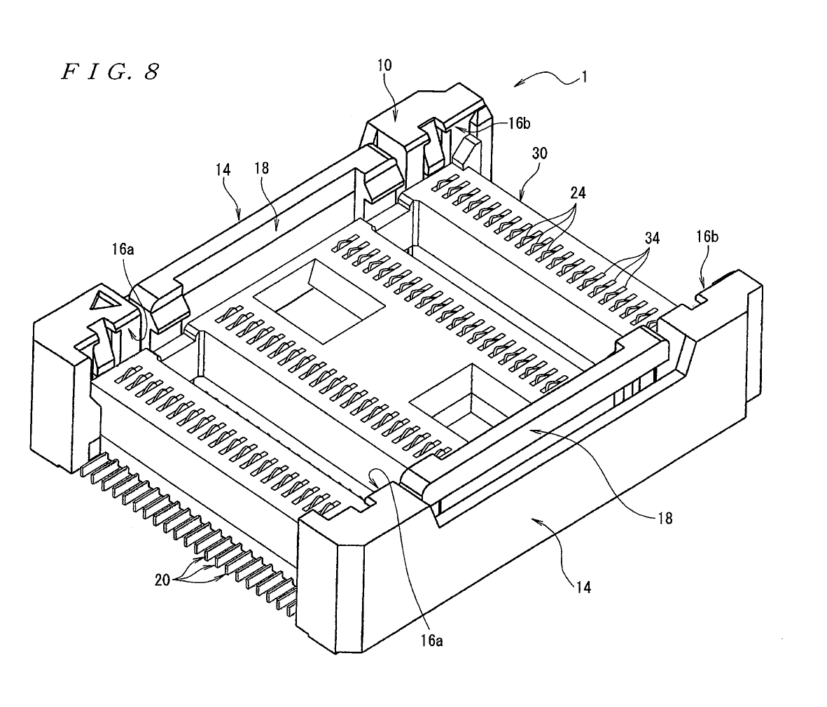

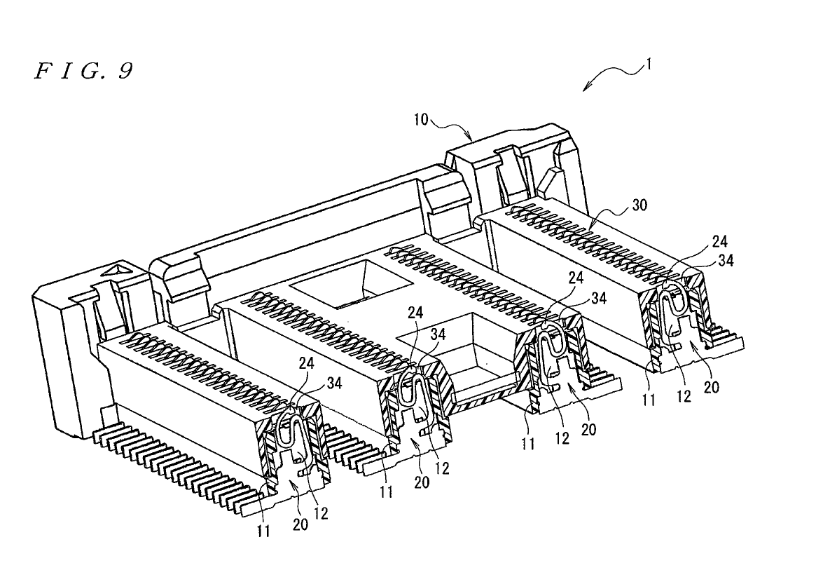

When the protective cover 30 is located in the upper position, a state is created in which the contact members 24 of the contacts 20 are covered by the protective cover 30 as shown in FIGS. 1 and 2. Furthermore, the protective cover 30 that is in the upper position can be pushed down to a position at which the lower ends of the cover members 31 of the protective cover 30 contact the upper surfaces of the step parts 11a of the contact accommodating sections 11 (hereafter referred to as a “lower position”). As shown in FIGS. 8 and 9, when the protective cover 30 is pushed down to the lower position, the contact members 24 of the contacts 20 protrude upward from the slots 34 that open in the upper surface of the protective cover 30.

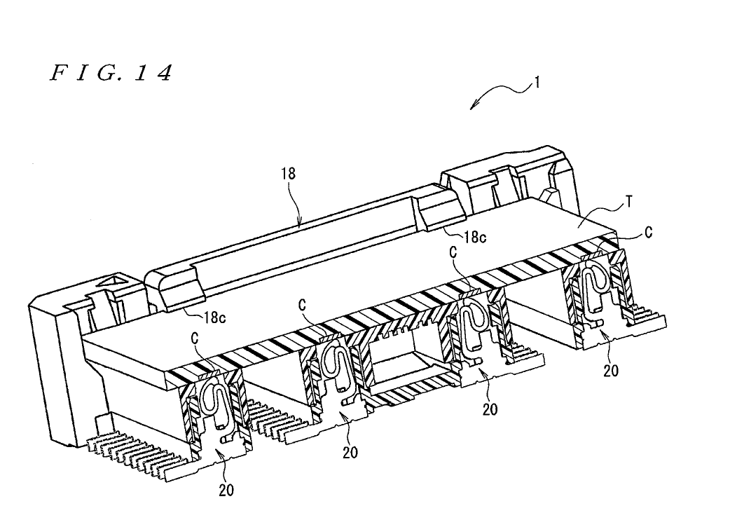

A method of securing the FLGA package T to the electrical connector 1 will now be described. As shown in FIGS. 13 and 14, the FLGA package T comprises an insulating housing and a plurality of the mating contacts C that are arranged on the undersurface of the housing. As shown in FIG. 1, the protective cover 30 of the electrical connector 1 in the initial state is disposed in the upper position. As a result, when the FLGA package T is not secured to the electrical connector 1, the contact members 24 of the contacts 20 are not exposed, so that the contact members 24 can be protected. When the FLGA package T is to be secured to the electrical connector 1, the FLGA package T is first disposed on the protective cover 30 of the electrical connector 1, which is in the initial state, with the side of the undersurface of this FLGA package T provided with the mating contacts C facing downward. In this case, the FLGA package T is such that the corner portions on the front side contact the side surfaces on the rear side of the positioning protruding members 16e provided on the guide members 16a of the housing 10, and the corner portions on the rear side contact the side surfaces on the front side of the positioning protruding members 32a provided on the side walls 32 of the protective cover 30. As a result, the FLGA package T is held on the protective cover 30 in a state in which the movement in a horizontal direction with respect to the housing 10 is restricted.

Next, the FLGA package T disposed on the protective cover 30 is pushed downward. As the FLGA package T is pushed downward, the protective cover 30 is also pushed downward. As a result of the FLGA package T being pushed downward in a state in which the undersurface of the FLGA package T is in contact with the upper surface of the protective cover 30, the FLGA package T is moved in a vertical direction, while maintaining a horizontal state. This makes it possible for the electrical connector 1 to prevent twisting caused by the FLGA package T being secured at an inclination.

As the FLGA package T is pushed downward, the surfaces of the mating contacts C provided on the undersurface of the FLGA package T make contact with the contact members 24 of the contacts 20 that protrude upward from the upper ends of the slots 34 in the protective cover 30. As the FLGA package T is pushed further downward, the mating contacts C provided on the undersurface of the FLGA package T are also pushed downward, so that the contact members 24 of the contacts 20 begin to be pushed downward by the mating contacts C. Once the contact members 24 of the contacts 20 begin to be pushed downward by the mating contacts C, a contact pressure begins to be applied to the contacts 20. The contact pressure between the contact members 24 of the contacts 20 and the mating contacts C is increased by the reaction force of the contacts 20 to which the contact pressure is applied. Here, the position of the contact members 24 in the vertical direction at the time of the initiation of the downward movement of the contact members 24 of the contacts 20 by the mating contacts C is referred to as a first position.

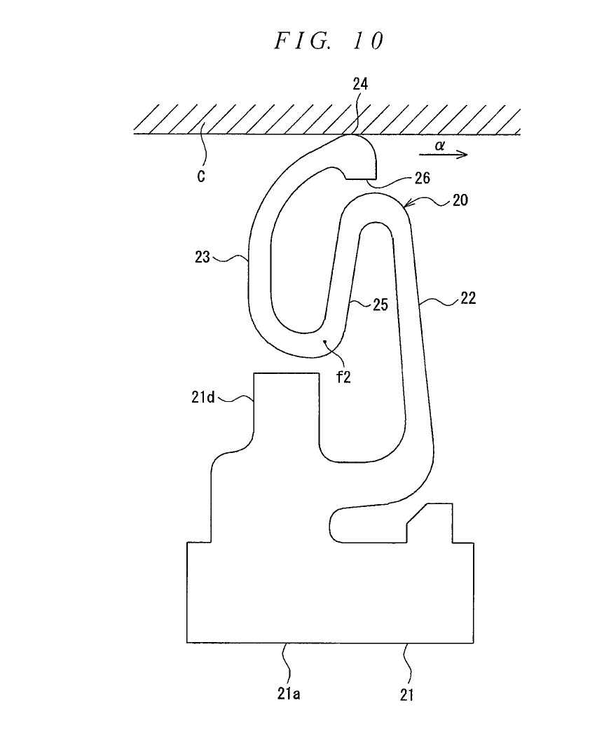

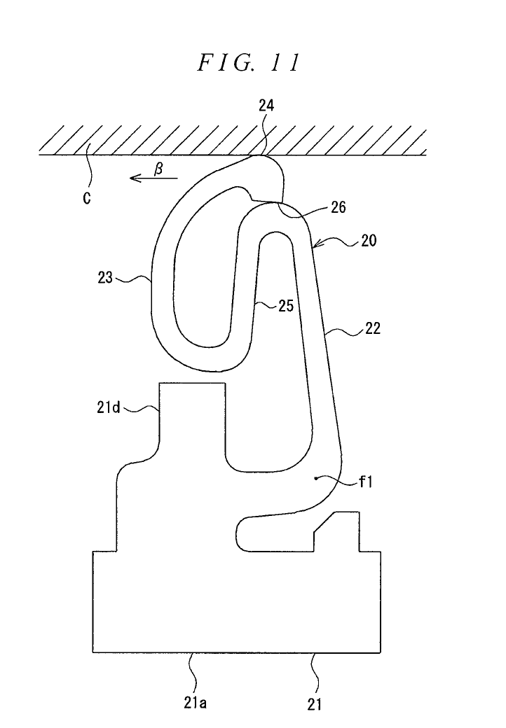

As shown in FIG. 10, the contacts 20 whose contact members 24 are in the first position have a gap between the lower ends of the abutment members 26 of the second springs 23 and the upper ends of the first springs 22, and also have a gap between the lower ends of the second springs 23 and the upper ends of the anti-overstress members 21d of the bases 21. Once the contact members 24 of the contacts 20 that are in the first position begin to be pushed downward by the mating contacts C, as a result of the FLGA package T being pushed downward, mainly the second springs 23 of the contacts 20 begin to flex. As the contact members 24 of the contacts 20 that are in the first position are pushed downward, the abutment members 26 of the second springs 23 contact the upper ends of the first springs 22, as shown in FIG. 11. Once the abutment members 26 of the second springs 23 contact the upper ends of the first springs 22, further flexing of the second springs 23 is inhibited. The position in the vertical direction of the contact members 24 of the contacts 20 in this case is referred to as a second position, and the zone where the contact members 24 are pushed from the first position to the second position is referred to as a first zone.

Here, each of the contacts 20 is considered as a model in which two levers, i.e., the first spring 22 and the second spring 23, are linked. As shown in FIG. 10, when the contact member 24 is in the first position, the position in the horizontal direction of the contact member 24 constituting the effort from the mating contact C is located to the rear side of the position in the horizontal direction of a fulcrum f2 of the second spring 23. Furthermore, the fulcrum f2 of the second spring 23 is located in the vicinity of the portion that is bent back from the lower end portion of the linking member 25. Therefore, the contact member 24 moves rearward (in a direction of arrow α in FIG. 10), as a result of the flexing of the second spring 23 of each of the contacts 20. Accordingly, when the contact members 24 of the contacts 20 that are in the first position are pushed downward, the contact members 24 move rearward in a first direction (in the direction of the arrow α in FIG. 10) with respect to the mating contacts C. That is, in the first zone where the contact members 24 of the contacts 20 are pushed from the first position to the second position by the mating contacts C, the contact members 24 of the contacts 20 move rearward (in the direction of the arrow α in FIG. 10) while sliding over the surfaces of the mating contacts C. As a result, the surfaces of the mating contacts C are wiped rearward (in the direction of the arrow α in FIG. 10) by the contact members 24 of the contacts 20.

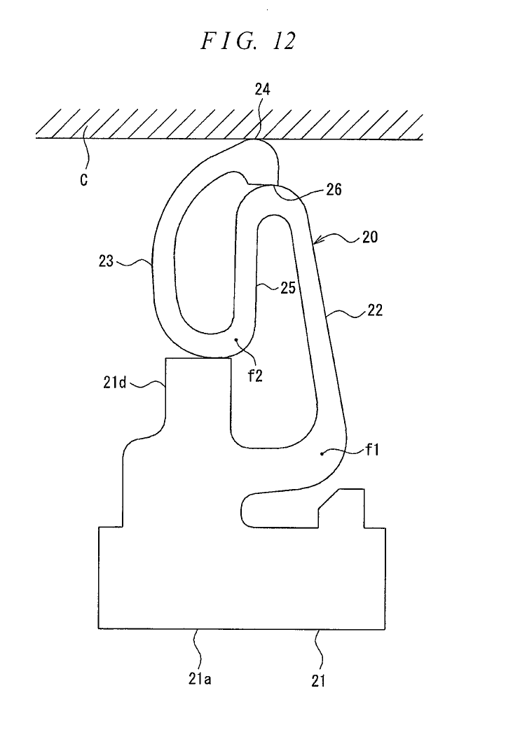

Next, when the contact members 24 of the contacts 20 that are in the second position are pushed further downward by the FLGA package T being pushed downward together with the protective cover 30, the first springs 22 of the contacts 20 begin to flex. As the contact members 24 of the contacts 20 that are in the second position are pushed downward, the lower ends of the second springs 23 contact the upper surfaces of the anti-overstress members 21d of the bases 21, as shown in FIG. 12. Once the lower ends of the second springs 23 contact the upper surfaces of the anti-overstress members 21d of the bases 21, any further flexing of the first springs 22 is inhibited. The position of the contact members 24 of the contacts 20 in the vertical direction in this case is referred to as a third position, and the zone where the contact members 24 are pushed from the second position to the third position is referred to as a second zone.

Each of the contacts 20 is considered as a model in which the two levers, i.e., the first spring 22 and the second spring 23, are linked. As shown in FIG. 11, when the contact member 24 is in the second position, the position in the horizontal direction of the contact member 24 constituting the effort from the corresponding mating contact C is located to the front side of the position in the horizontal direction of a fulcrum f1 of the first spring 22. Furthermore, the fulcrum f1 of the first spring 22 is located in the vicinity of the bent portion between the portion extending rearward from one side portion of the fastening member 21a of the base 21 and the portion extending upward from the rear end of this portion extending rearward. Therefore, the contact member 24 moves forward in a second direction (in a direction of arrow P in FIG. 11), as a result of the flexing of the first spring 22 of each of the contacts 20. Accordingly, when the contact members 24 of the contacts 20 that are in the second position are pushed downward, the contact members 24 move forward (in the direction of the arrow β in FIG. 11) with respect to the mating contacts C. That is, in the second zone where the contact members 24 of the contacts 20 are pushed from the second position to the third position by the mating contacts C, the contact members 24 of the contacts 20 move forward (in the direction of the arrow β in FIG. 11) while sliding over the surfaces of the mating contacts C. As a result, the surfaces of the mating contacts C are wiped forward by the contact members 24 of the contacts 20.

Thus, the contact members 24 of the contacts 20 move in a reciprocating manner in the direction of length while sliding over the surfaces of the mating contacts C when the contact members 24 are pushed from the first position to the third position by the mating contacts C. Specifically, the contact members 24 of the contacts 20 are displaced downward approximately 0.195 mm while being pushed by the mating contacts C from the first position to the third position. In this case, the contact members 24 of the contacts 20 are displaced rearward approximately 0.18 mm in the first zone, and are displaced forward approximately 0.46 mm in the second zone. As a result, in cases where contacts whose pattern length is approximately 1.0 mm are used as the mating contacts C, it is possible for the electrical connector 1 to ensure that the distance to which the surfaces of the mating contacts C can be wiped with the required contact pressure is approximately 0.64 mm. In other words, the contacts 20 can ensure a long wiping distance compared to the contacts whose contact members are displaced only in one direction (approximately two times the conventional electrical connector 100), as a result of the contact members 24 moving in a reciprocating manner in the forward-rearward direction. Consequently, the electrical connector 1 makes it possible to prevent insufficient contact between the mating contacts C of the FLGA package T and the contact members 24 of the contacts 20 when the FLGA package T is secured.

Moreover, as shown in FIGS. 13 and 14, in a state in which the contact members 24 of the contacts 20 are pushed to the third position by the mating contacts C, the FLGA package T disposed on the protective cover 30 is locked by the locking pieces 18c provided on the locking members 18 of the housing 10. This completes the attachment of the FLGA package T to the electrical connector 1. When the attachment of the FLGA package T to the electrical connector 1 is completed, the protective cover 30 is disposed in the lower position.

Furthermore, when the FLGA package T disposed on the protective cover 30 is locked by the locking pieces 18c provided on the locking members 18 of the housing 10, the protective cover 30 and FLGA package T are returned slightly upward by the clearance of the housing 10. In this case, the flexing of the first springs 22 of the contacts 20 that are pushed downward by the mating contacts C is returned slightly, and the contact members 24 of the contacts 20 move rearward with respect to the mating contacts C. Thus, strictly speaking, the contact members 24 of the contacts 20 change the direction of movement with respect to the mating contacts C two times by the time the attachment of the FLGA package T to the electrical connector 1 is completed.

As was described above, the contacts 20 are formed such that when the contact members 24 are pushed downward by the mating contacts C, the direction in which the contact members 24 are caused to move by the flexing of the first springs 22 and the direction in which the contact members 24 are caused to move by the flexing of the second springs 23 are opposite from each other. Moreover, the second springs 23 are formed so as to flex more easily than the first springs 22. As a result, the contact members 24 of the contacts 20 move in a reciprocating manner in the forward-rearward direction while sliding over the surfaces of the mating contacts C when being pushed downward by the mating contacts C. Accordingly, the contacts 20 make it possible to effectively ensure a long effective wiping distance as a result of the contact members 24 moving in a reciprocating manner. Consequently, the contacts 20 are especially advantageous when handling the miniaturization of the electrical connector 1 or an increase in the density of the mating contacts C in FLGA packages T.

Furthermore, in the electrical connector 1, when the abutment members 26 of the second springs 23 contact the upper ends of the first springs 22, any further flexing of the second springs 23 is inhibited; therefore, the direction of wiping can be changed reliably. Moreover, in the electrical connector 1, when the lower ends of the second springs 23 contact the upper surfaces of the anti-overstress members 21d of the bases 21, any further flexing of the first springs 22 is inhibited; therefore, excessive flexing of the first springs 22 is prevented, which can in turn prevent the contacts 20 from undergoing plastic deformation.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A contact that makes electrical contact with a flat plate-form mating contact, comprising,
a base having a fastening member for securing the base to an insulating housing of an electrical connector;
a first spring that extends upward from the base;
a linking member that extends downward from a tip end of the first spring;
a second spring that is more easily flexed than the first spring that extends upward from a lower end of the linking member, the second spring having a contact member at a tip end thereof; and
the first spring moving the contact member in a first direction when a contact force is applied to the contact member in a direction of the base and the second spring moving the contact member in a second direction opposite from the first direction when a further contact force is applied to the contact member in a direction of the base.

2. The contact of claim 1, wherein the first direction and the second direction are substantially perpendicular to a direction of the contact force and the further contact force.

3. The contact of claim 1, wherein the first spring, the linking member, and the second spring form a substantially S-shape.

4. The contact of claim 1, wherein on a side opposite from the contact member the tip end of the contact spring has an abutment member that engages the tip end of the first spring to inhibit flexing of the second spring.

5. The contact of claim 1, wherein an anti-overstress member extends from the base and engages a lower end of the second spring opposite the tip end of the second spring to inhibit flexing of the first spring.

6. The contact of claim 1, wherein the contact is a substantially flat plate.

7. An electrical connector that receives a semiconductor package, comprising,
an insulating housing provided with a plurality of contacts, each of the contacts having a base with a fastening member for securing the base to the insulating housing, a first spring that extends upward from the base, a linking member that extends downward from a tip end of the first spring, and a second spring that that is more easily flexed than the first spring that extends upward from a lower end of the linking member, the second spring having a contact member at a tip end thereof; and
the first spring moving the contact member in a first direction when a contact force is applied to the contact member in a direction of the base and the second spring moving the contact member in a second direction opposite from the first direction when a further contact force is applied to the contact member in a direction of the base.

8. The electrical connector of claim 7, wherein the first direction and the second direction are substantially perpendicular to a direction of the contact force and the further contact force.

9. The electrical connector of claim 7, wherein the first spring, the linking member, and the second spring form a substantially S-shape.

10. The electrical connector of claim 7, wherein on a side opposite from the contact member the tip end of the contact spring has an abutment member that engages the tip end of the first spring to inhibit flexing of the second spring.

11. The electrical connector of claim 7, wherein an anti-overstress member extends from the base and engages a lower end of the second spring opposite the tip end of the second spring to inhibit flexing of the first spring.

12. The electrical connector of claim 7, wherein the contact is a substantially flat plate.

13. The electrical connector of claim 7, wherein a protective cover is arranged on the insulating housing, the protective cover having a plurality of slots that receive the contacts.

14. The electrical connector of claim 13, wherein the protective cover is moveable between an upper position and a lower position, the protective cover covering the contacts in the upper position and exposing the contacts in the lower position.

15. The electrical connector of claim 7, wherein the contact force and the further contact force is applied to the contact member by a flat plate-form mating contact on the semiconductor package.

16. The electrical connector of claim 7, wherein the contact member engages a surface of the flat plate-form mating contact during movement in the first direction and the second direction.
